(19) United States
(12) Patent Application Publication
(10) Pub. No.: US 2014/0190339 A1
(43) Pub. Date: Jul. 10, 2014

(54) Hand Controlled Volume Potentiometer Knob And Related Methods

(71) Applicant: Chad Smith, Northport, AL (US)

(72) Inventor: Chad Smith, Northport, AL (US)

(21) Appl. No.: 14/150,479

(22) Filed: Jan. 8, 2014

Related U.S. Application Data
(60) Provisional application No. 61/751,090, filed on Jan. 10, 2013.
(60) Provisional application No. 61/800,569, filed on Mar. 15, 2013.

(51) Int. Cl. G10H 1/46

(52) U.S. Cl. CPC G10H 1/46
USPC 84/741

(57) ABSTRACT

A hand controlled volume potentiometer knob has a knob body for coupling with a potentiometer shaft on the body of a guitar and at least one arm extending from the knob body and angled to place a distal end of the arm proximate a playing area of the guitar. The arm allows a user to control guitar volume without removing his hand from a playing area of the guitar, by actuating the arm with a finger to turn the knob and thereby rotate the potentiometer shaft.

### RELATED APPLICATIONS

This application claims priority to U.S. Provisional Patent Application No. 61/800,569, filed 15 Mar. 2013, and to U.S. Provisional Patent Application No. 61/751,090, filed 10 Jan. 2013.

### BACKGROUND

It is often desirable, during a live performance, for a guitar player to adjust the volume knob on his or her guitar. Volume knobs on guitars are predominately small, round knobs located on the body of the guitar. Conventional knobs are not well adapted for executing swift volume swells or fine-tuning the volume level quickly during live performance, as these knobs require that the musician move his or her hand strumming or picking hand away from the strings in order to work the knob. In addition, the musician must generally grasp the knob between the thumb and one or more fingers in order to adjust volume, which is additionally problematic when the musician is holding a guitar pick. Thus, the inability of the musician to quickly adjust volume levels during performance limits the usefulness of contemporary volume knobs.

### SUMMARY

What is disclosed is a hand controlled volume potentiometer knob including an arm that extends proximate a playing area of the guitar, such that the arm may be moved to adjust volume of the guitar without interrupting play of the guitar.

In one embodiment, a hand-controlled volume potentiometer knob includes a knob body for coupling with a potentiometer shaft on the body of a guitar, and one or more arms extending from the knob body. At least a first of the arms extends towards a playing area of the guitar when the knob body couples with the potentiometer shaft, to allow a user to control guitar volume by moving the first arm to turn the knob, from the playing area of the guitar.

In one embodiment, an injection molded, hand-controlled volume potentiometer knob includes a knob body having an internal channel for fitting with a potentiometer shaft on a guitar body. An arm extends upward and outward from the knob body. The arm includes a distal contact feature for facilitating placement of a user's finger with the knob. A user turns the knob by moving the arm with a finger placed at the distal contact feature. The distal contact feature rests proximate the strings of the guitar when in a neutral position, such that the user may adjust guitar volume while strumming or picking the strings.

### BRIEF DESCRIPTION OF THE FIGURES

FIG. 1 shows a front view of a hand controlled volume potentiometer knob with two arms, according to an embodiment.

FIG. 2 shows a bottom view of knob of FIG. 1.

FIG. 3 shows a side view of the knob of FIG. 1.

FIG. 4 shows a front view of a hand controlled volume potentiometer knob with a single arm, according to an embodiment.

FIG. 5 shows a front view of a hand controlled volume potentiometer knob with a single arm and a distal contact feature, according to an embodiment.

FIG. 6 shows a front view of a hand controlled volume potentiometer knob having one extended wing with a finger-activated swivel pad, according to an embodiment.

FIG. 7 shows a bottom view of a hand controlled volume potentiometer knob configured to attach to a potentiometer shaft with a flat key, showing also a dish-shaped distal contact feature, according to an embodiment.

FIG. 8 shows a cross-sectional view of a hand controlled volume potentiometer knob with a tapered channel for attaching to a potentiometer shaft, also showing a raised distal contact feature, according to an embodiment.

FIG. 9 shows a cross-sectional view of a hand controlled volume potentiometer knob with a threaded internal channel, according to an embodiment.

FIG. 10 is a first side perspective view of a hand controlled volume potentiometer knob, according to an embodiment.

FIG. 11 is a second side perspective view of the hand controlled volume potentiometer knob of FIG. 10.

FIG. 12 shows an exemplary hand controlled volume potentiometer knob, according to an embodiment.

FIG. 13 is a top view showing a hand controlled volume potentiometer knob being used during play of a guitar, according to an embodiment.

FIG. 14 is a top view of a guitar equipped with a hand controlled volume potentiometer knob, according to an embodiment.

FIG. 15 is a side view of the guitar and hand controlled volume potentiometer knob of FIG. 14.

### DETAILED DESCRIPTION OF THE FIGURES

Reference will now be made to the attached drawings, where multiple elements within the figure may not be labeled for the sake of clarity, and the figures may not be drawn to scale. This application also includes an attached Appendix A, which forms a part of this disclosure.

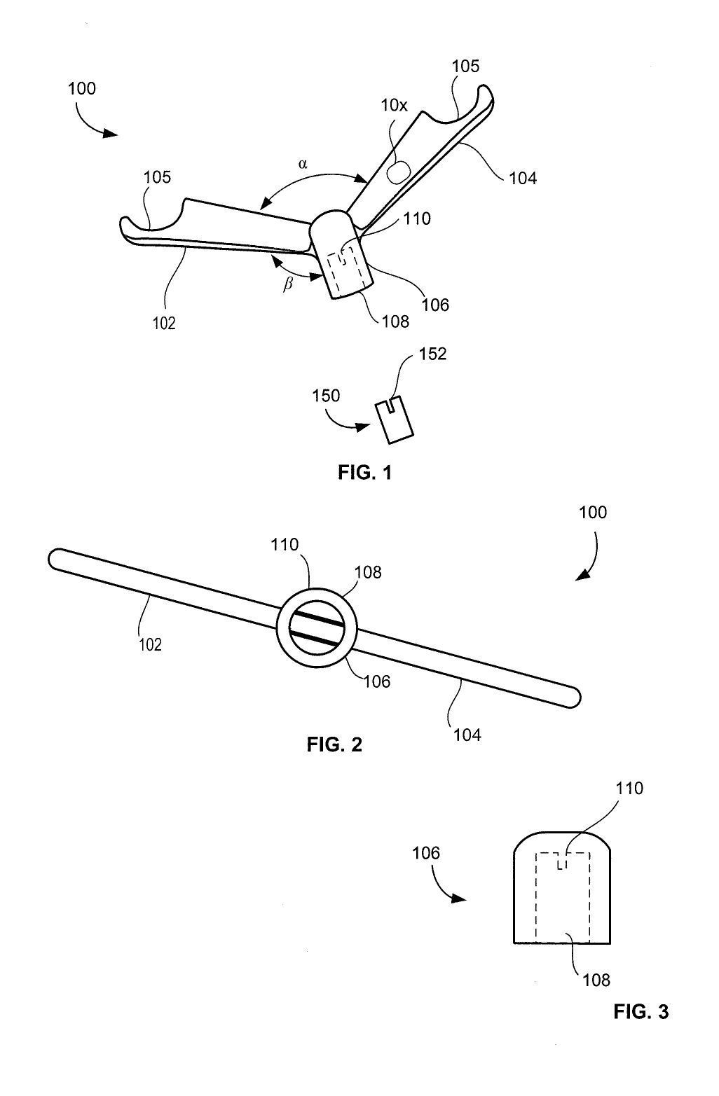

FIG. 1 shows a front view of a hand controlled volume potentiometer knob 100 with two wings. First and second arms or wings 102 and 104 attach to a knob body 106 configured to attach to a volume potentiometer shaft 150 on a guitar body (shown detached from the guitar body, for ease of illustration). Arms 102 and 104 extend from opposite sides of knob body 106 forming an angle α between arms 104. Angle α is preferably 90 degrees or greater so that arms 102 and 104 may be individually contacted by a user's finger without interfering with the user's palm or the heel of the user's hand. Arms 102 and 104 facilitate control of knob 100 by a user's finger, while the user continues strumming the guitar or without significant break from picking or strumming. The user may thereby vary the guitar's volume during continuous or significantly unbroken play, for example using his or her little finger while strumming or picking the guitar with his or her remaining fingers. It will be appreciated that knob 100 may also be adjusted with a finger or fingers other than the user's little finger. The length and shape of arms 102/104 and other arms disclosed herein advantageously allows a user to control guitar volume from anywhere along arm 102/104. The knob arms disclosed herein extend volume control out from the potentiometer to a variety of positions closer to the guitar strings. A user may, for example, pinch arm 102/104 between his or her fingers and in this way control guitar volume, or a user may take advantage of a distal contact feature described below, in order to control guitar volume.

Arm 102/104 joins with knob body 106 to form an angle β between knob body 106 and a bottom surface of arm 102/104. Angles α and β are selected to place the distal end of arm 102/104 such that it can be easily reached and actuated during play of a guitar. In one aspect, angles α and β are selected to place the distal end of arm 102/104 (i.e., proximate a distal contact feature, described below) in-plane with or proximate and just above the strings of a guitar, so that a user may continue strumming while adjusting volume with his or her little finger.

Although knob 100 is shown with two wings 102, 104, knob 100 may include one, three, or more wings without departing from the scope hereof. One or both of wings 102 and 104 may include a distal contact feature 105 for facilitating control of knob 100 by a user's finger. Digital contact feature 105 may be a notch, cutout, friction pad or other control-enhancing feature. Distal contact feature 105 may feature smooth walls or include a series of angles forming a finger dish; however, distal contact feature 105 is not limited to the shapes shown in the accompanying Figures. A lateral cut-out 107 positioned between knob body 106 and distal contact feature 105 may be formed through arm 102 and/or 104, to facilitate attaching knob 100 to a keychain, to a key hook of a shoulder bag or case, to a carabiner, or to a cord to transport and/or keep track of knob 100. Cutout 107 may also reduce weight of knob 100 and/or provide a secondary contact point along arm 102/104.

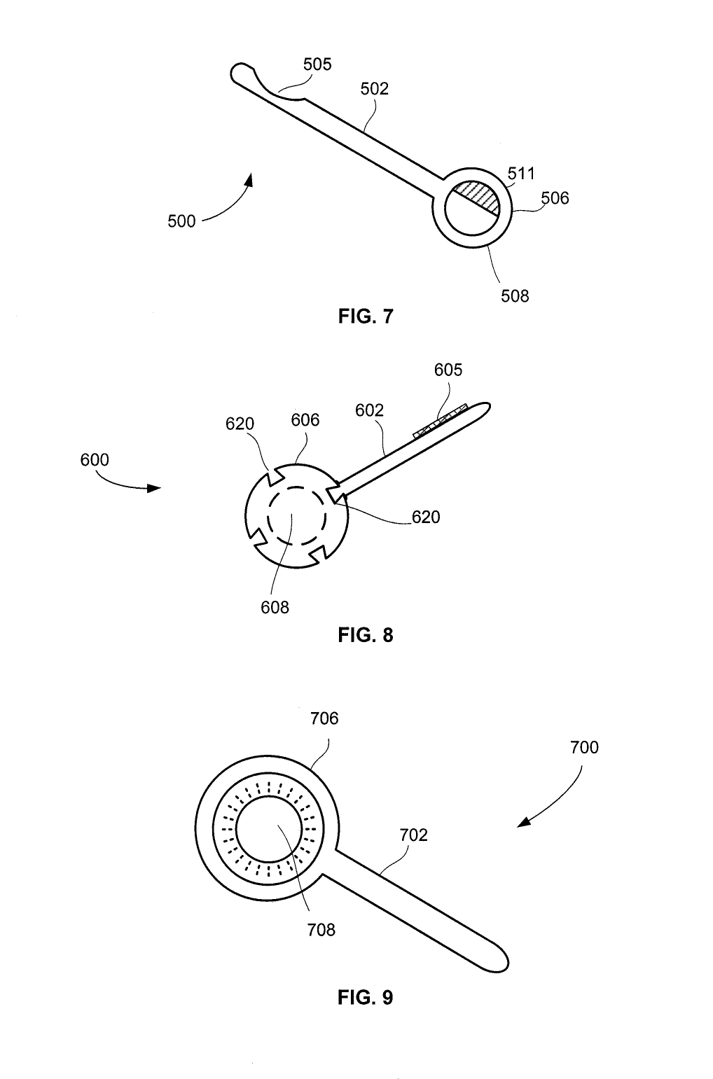

There are three common formats for variable electronic component shafts. A first format has a slot formed in the end of the shaft to mate with a matching key in a controlling knob. See for example slot 152 within shaft 150, FIG. 1. A second format has a shaft with a flat running the length of the shaft that mates with a flat key formed within the controlling knob. A third format is a cylindrical shaft, upon which a controlling knob with a fixing screw attaches, the screw functioning to key the controlling knob to the shaft. Knob 100 is illustratively keyed to fit the slotted shaft format, although it may be configured to fit with other formats without departing from the scope hereof (see, e.g., FIGS. 7-9).

FIG. 2 is a bottom view of knob 100, and FIG. 3 shows an exemplary side view of knob body 106. For ease of illustrating channel 108 and key 110, wings 102 and 104 are not shown in FIG. 3. FIGS. 1, 2 and 3 are best viewed together with the following description. Knob body 106 is formed with a cylindrical channel 108 to accommodate insertion of potentiometer shaft 150. A key 110 is disposed within channel 108 to mate with slot 152 of shaft 150. Key 110 operates to prevent knob 100 from slipping on shaft 150 during operation. Thus, when the user activates knob 100 via wing 102 and/or 104 (or other extensions as described above and below), the user simultaneously activates potentiometer shaft 150 and controls guitar volume.

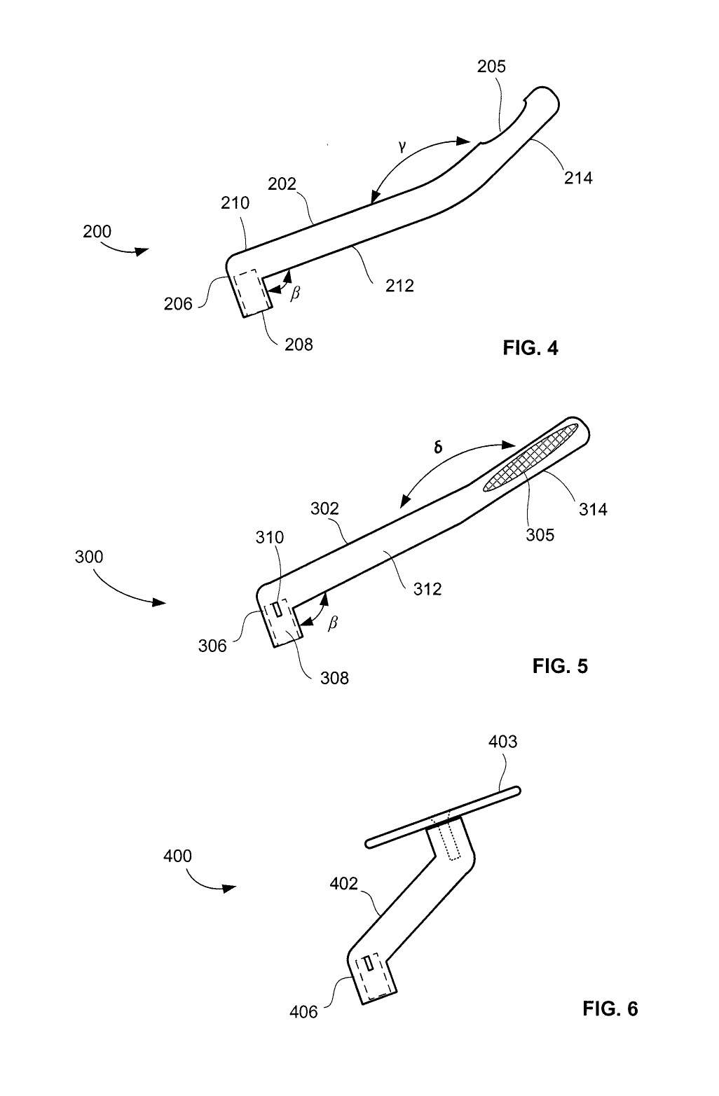

FIG. 4 is a side view of a hand controlled volume potentiometer knob 200 with a single arm or wing 202 connected to a knob body 206. Knob body 206 is formed with a channel 208 and a key 210 for coupling with a shaft (e.g., shaft 150 of FIG. 1). Arm or wing 202 includes a first portion or extension 212 extending from knob body 206 at approximately a 90 degree angle (although this may vary without departing from the scope hereof), and a second portion or extension 214 extending from extension 212 at an angle γ. Angle γ as shown is an obtuse angle to facilitate activation of knob 200 by a single finger without significant break in playing of a guitar. For example, knob 200 is sized and angles designed such that extension 214 lies more or less in plane of the user's hand when strumming or picking the strings of a guitar. A distal contact feature 205, here a cutout, is placed with second extension 214 to facilitate controlling knob 200 with a finger.

FIG. 5 is a side view of a hand controlled volume potentiometer knob 300 with a single arm 302 extending from a knob body 306. Arm 302 includes a first portion 312 extending from knob body 306, and a second portion 314 extending outward and slightly upward from portion 312. First and second portions 312 and 314 form an obtuse angle δ therebetween. First portion 312 angles outward and upward from knob body 306 at an angle that is greater than 90 degrees (i.e., here, angle β is greater than 90 degrees, whereas in FIG. 4, angle β is about 90 degrees. Thus, angle δ may be greater than angle γ while still positioning second portion 314 more or less in plane with the strings of the guitar (see, e.g., FIG. 15).

Knob 300 includes a distal contact feature 305. Distal contact feature 305 may be an area of increased friction, a finger dish, a raised area, a notch, an abrasive area, a featured area (i.e., having more surface features than the rest of the arm), or any other feature that may facilitate placement of a user's finger with the distal end of aim 302 (e.g., with second portion 314). Distal contact feature 305 is shown on a side of arm 302, rather than atop the arm, as with distal contact feature 105 of FIG. 1. It will be appreciated that contact features may be placed atop and/or with sides of the arms disclosed herein, without departing from the scope hereof.

In an embodiment, arms and knob bodies disclosed herein may be detachable from one another, so that the knob is configurable for optimal control. For example, these components may vary in length and/or size for selectively coupling to meet the requirements of a particular user. In another embodiment, angles between knob body 106, 206, 306 and respective arm 102/104, 202 or 302 may be customizable. For example, knob bodies and arms disclosed herein may be made from or incorporate a material that may be bent to a desired shape, but which has sufficient tensile strength to maintain the desired shape while in use. Angles between first and second arm portions disclosed herein may likewise be customizable by a user, such that a single hand controlled volume potentiometer knob (100, 200, 300) may be manipulated into and may hold a wide variety of positions, and as such may be customized to fit a variety of user hand positions and sizes, as well as allowing a user to customize the knob for potentiometer and bridge placement on a variety of guitars.

Arms 102/104, 202 and 302 may include grips fabricated from metal, plastic, or rubber that are textured to provide increased traction (e.g., distal contact feature 305 may include these, or grips may cover other portions or all of arm 302 and/or knob body). A multi-arm configuration (e.g., FIGS. 1-3) may facilitate bidirectional control as compared to a knob having a single arm. Likewise, it will be appreciated that arms are not limited to being placed directly across from one another, but may be closer together to form an angle of less than 180 degrees therebetween.

FIG. 6 shows a front view of a hand controlled volume potentiometer knob 400 having a pivoted plate or swivel pad 403 at the distal end of an arm 402. Swivel pad 403 is for example a disk rotatable about a pivot point 405, connecting internally to the potentiometer shaft of a guitar (connection not shown) such that swiveling of pad 403 adjusts volume while arm 402 and a knob body 406 remain stationary. As noted above, swivel pad 403 may include circumferential notches, a frictional pad or gripping surface, one or more bumps or grooves, or other surface or side features that facilitate rotating disc 403, and thereby rotating the potentiometer shaft of the guitar. via the disc. Dimensions and positioning of knob 400 are selected to place swivel pad 403 proximate or in the plane of the strings, such that a guitar player may adjust guitar volume without significant break in play.

It will be appreciated that swivel pad 403 may alternately be mounted directly with knob body 406, and arm 402 omitted.

FIG. 7 shows a bottom view of an exemplary hand controlled volume potentiometer knob configured to attach to a shaft with a flat key format. As shown in FIG. 7, knob 500 includes a single arm 502 extending from a knob body 506. A lateral distal contact feature (a notch or finger dish) 505 facilitates placement of a user's finger with the distal end of arm 502. A channel 508 includes a flat key 511 that matches the flat key of the shaft, thereby preventing knob 500 from slipping (spinning) on the shaft. Key 511 may be formed of one or more spring plates that are inserted into the channel to secure knob 500 to the shaft.

FIG. 8 is a cross-sectional view of a hand controlled volume potentiometer knob 600 with a tapered internal channel 608. Channel 608 is substantially cylindrical with a top portion (e.g., the top half) having a taper such that a knob body 606 may couple by friction fit to many shafts. For example, knob body 606 may couple to a shaft by a press fit. The angle of the channel 608 taper is for example between 0 degrees and 5 degrees. Knob body 606 may be formed with any of the knob body features described above (e.g., with a groove, key or other internal features) to provide an alternate or additional means of securing knob 600 to the shaft. Knob 600 is shown with a lateral, raised finger pad or contact feature 605 positioned proximate a distal end of an arm 602.

As described above, contact feature 605 may be textured, include a gripping surface or have surface features that facilitate activating knob 600 with a finger placed with contact feature 605. Optionally or additionally, contact feature 605 may be a compressible material that conforms to a user's finger to help retain the finger in place upon contact feature 605. Knob body 606 may include one or more circumferentially-arranged slots 618 sized to fit a proximal end feature 620 of arm 602. Knob 600 may therefore be disassembled if desired, and may be reassembled by sliding proximal end feature 620 into a user-chosen slot 618 that places arm 602 and contact feature 605 in a “best play” position for a particular guitar player.

FIG. 9 is a cross-sectional view a hand controlled volume potentiometer knob 700 having a single arm 702 and a knob body 706 with an internally-threaded channel 708, to fit with a threaded shaft. It will be appreciated that, although not shown, knob 700 may feature an angled arm, a distal contact feature or other features of above-described knobs 100-600.

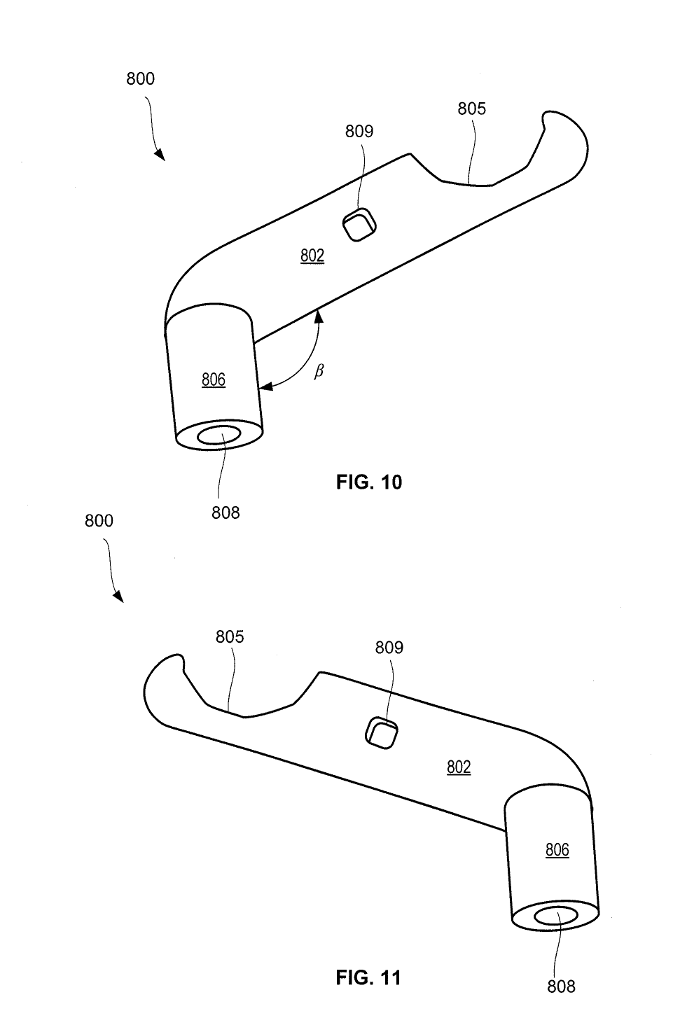

FIGS. 10 and 11 are perspective side views of a hand controlled volume potentiometer knob 800, including a single arm 802 extending outward and upward of a knob body 806. Arm 802 is for example configured as a “fin” rising up and off of a top surface of knob body 806. An internal channel 808 of knob body 806 may include any of the securing features described above with respect to knobs 100-700. A distal notch or contact feature 805 within arm 802 provides for secure placement of a user's finger with arm 802. A lateral cut-out 809 positioned between knob body 806 and distal cutout 805 allows a user to attach knob 800 to a keychain, to a key hook of a shoulder bag or case, to a carabiner, or to a cord to transport and/or keep track of knob 800. Cutout 809 may also reduce weight of knob 808 and/or provide a secondary contact point along arm 802. Angle β between knob body 806 and arm 802 is selected to facilitate use of knob 800 while playing a guitar, as described above.

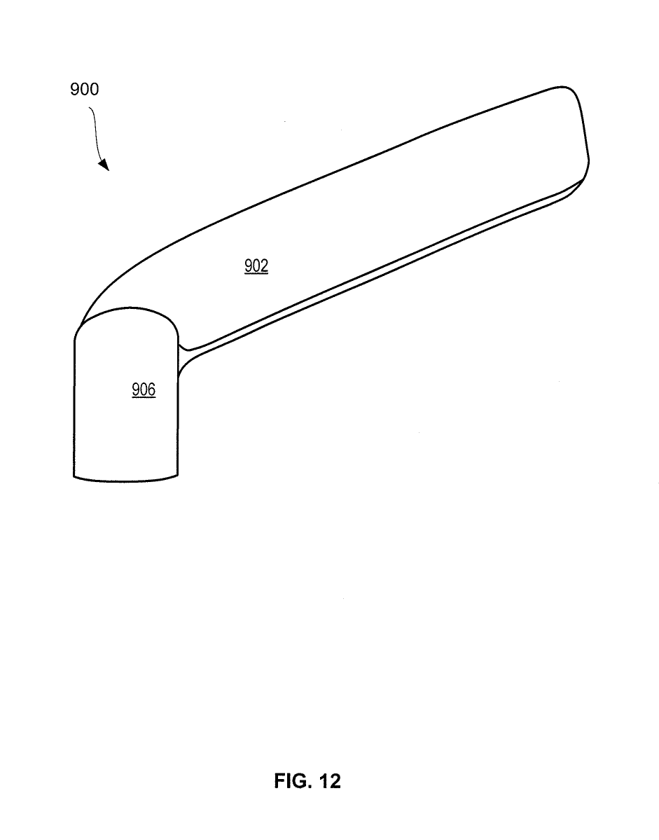

FIG. 12 is a side view of a hand controlled volume potentiometer knob 900. Knob 900 is similar to knob 800, and includes a single arm 902 extending outward and upward of a knob body 906; however, knob 900 does not include a distal contact feature.

The above-described hand controlled volume potentiometer knobs may be fabricated from one or more materials selected from metals, metal alloys (e.g., stainless steel), plastics, rubber, carbon fiber, fiberglass, wood, ceramics and combinations thereof. The knob and arm(s) may be conveniently produced as a single piece by injection molding. It will be appreciated that any feature described with respect to one of knobs 100-900 may be incorporated into another of knobs 100-900 without departing from the scope thereof. In one example, knob 800 may include any of the internal channel features described with respect to knobs 100-700, knob 600 may be configured with a disc extending from arm 602, knob 900 may include more than a single arm, etc.

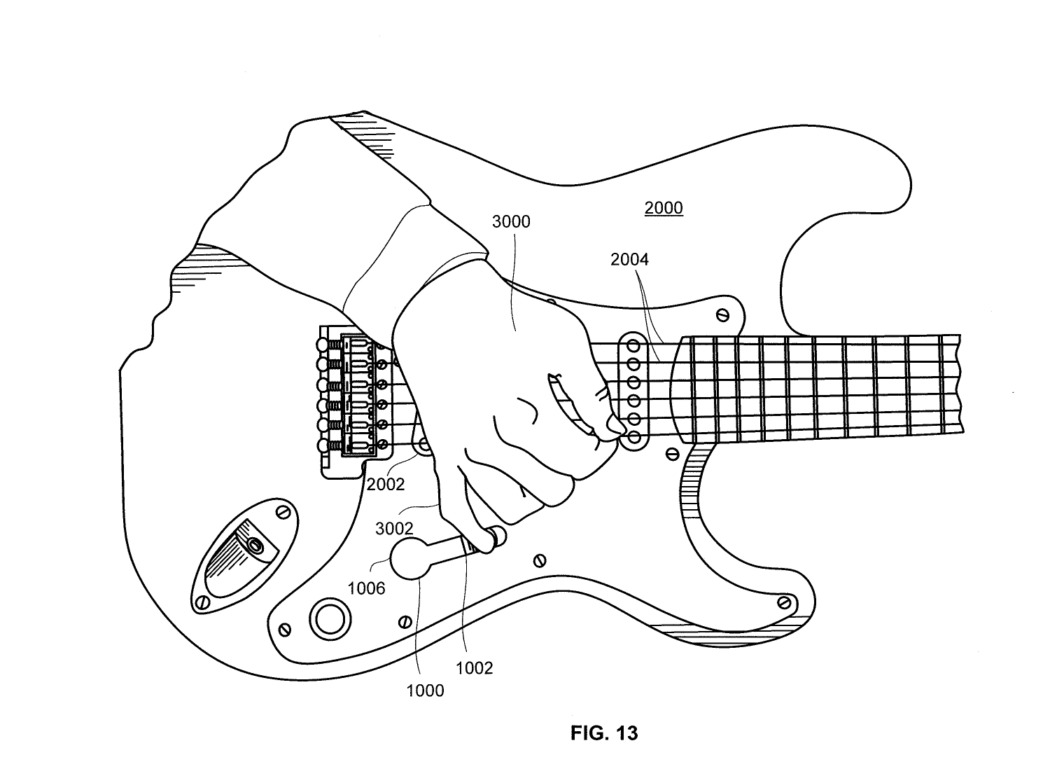

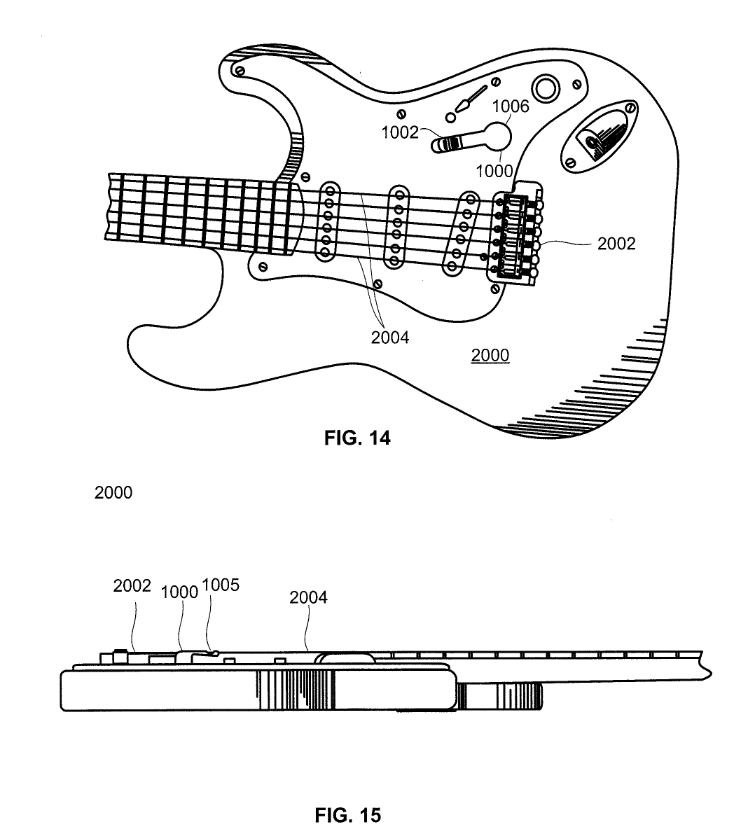

FIG. 13 shows a hand controlled volume potentiometer knob 1000 on a guitar 2000 in use by a guitar player. FIGS. 14 and 15 are front and side views of knob 1000 on guitar 2000, when guitar 2000 is not in play. It will be appreciated that any of knobs 100-900 or combinations thereof may serve as knob 1000. An arm 1002 extends outward from a knob body 1006, proximate a playing area of a guitar 2000 (e.g., proximate bridge pickup 2002). The distal end of arm 1002 (including any distal contact feature or notch 1005, FIG. 15) may lie parallel to strings 2004 of guitar 2000 (only two strings 2004 are labeled), or it may angle toward the strings. Arm 1002 may also extend slightly upward from knob body 1006 to place the distal end in plane with the user's hand 3000 or little finger 3002 when the user's hand is placed with strings 2004 during play (i.e., strumming or picking). The user is able to change guitar volume with a single finger without disrupting play of guitar 2000, or at least with minimal disruption as compared with the disruption involved in adjusting a pinch-knob (thumb and finger grasp). Alternately, a user may place any finger at a best-fit position along arm 1002, or pinch arm 1002 between his or her fingers to control guitar volume with minimal-to-no disruption of play.

Changes may be made in the above hand controlled volume potentiometer knob without departing from the scope hereof It should thus be noted that the matter contained in the above description or shown in the accompanying drawings should be interpreted as illustrative and not in a limiting sense. For example, features described with respect to one of knobs 100-1000 may be incorporated into another of the disclosed hand controlled volume potentiometer knobs, without departing from the scope hereof. The following claims are intended to cover all generic and specific features described herein, as well as all statements of the scope of the present methods and systems, which, as a matter of language, might be said to fall there between.

What is claimed is:

1. A hand controlled volume potentiometer knob, comprising:
a knob body for coupling with a potentiometer shaft on the body of a guitar; and
at least one arm extending from the knob body and angled to place a distal end of the arm proximate a playing area of the guitar, to allow a user to control guitar volume without removing his hand from a playing area of the guitar by actuating the arm with a finger to turn the knob,.

2. The knob of claim 1, the arm including a distal contact feature proximate the distal end, for accommodating a user's finger to facilitate moving the arm with the finger to adjust guitar volume.

3. The knob of claim 2, the distal contact feature selected from the group consisting of a notch, a pad, a swivel pad, a featured area, a gripping material, an abrasive material, a shallow dish, a distal enlargement of the arm, a distal tapering of the arm, and a ledge.

4. The knob of claim 2, wherein the distal contact feature rests proximate the strings of the guitar when the knob is in a neutral position, such that the user may adjust guitar volume while strumming or picking the strings.

5. The knob of claim 1, the knob body including an internal channel shaped to accept the potentiometer shaft.

6. The knob of claim 5, the internal channel comprising a key, located within the channel, for mating with a key of the shaft, the key operable to prevent the knob body from slipping from or spinning around the shaft.

7. The knob of claim 6, the key within the channel comprising a blade for mating with a slot in the shaft, or a flat for mating with a flat formed on the shaft.

8. The knob of claim 1, the arm configured with the knob body such that the arm extends towards the playing area of the guitar when the knob is in a neutral position.

9. The knob of claim 1, a distal end of the arm lying substantially parallel to the guitar strings when the knob is in a neutral position.

10. The knob of claim 1, the playing area being the strings of the guitar.

11. The knob of claim 1, the knob being coupled with the shaft by friction.

12. The knob of claim 5, the internal channel being a threaded channel for mating with a threaded shaft.

13. The knob of claim 5, the internal channel being elastic to facilitate attachment to the potentiometer shaft when the potentiometer shaft has a larger external diameter than the internal diameter of the collar.

14. The knob of claim 1, the knob body and the arm forming a continuous, one-piece knob.

15. The knob of claim 1, wherein the knob body and the arm are fabricated from one or more of metal, metal alloy, plastic, rubber, carbon fiber, fiberglass, wood, and ceramic.

16. The knob of claim 1, the arm comprising a keyed end for attaching to a keyed slot within the knob body.

17. The knob of claim 1, the arm extending upwards and outwards from the knob body to form an angle greater than 90 degrees between a circumferential side of the knob body and a bottom edge of the arm.

18. The knob of claim 2, wherein the distal contact feature rests proximate the strings of the guitar when the knob is in a neutral position, such that the user may adjust guitar volume while strumming or picking the strings.

19. A hand controlled volume potentiometer knob, comprising:
a knob body having an internal channel for fitting with a potentiometer shaft on a guitar body, and
an arm extending upward and outward from the knob body and towards a playing area of the guitar, the arm including a distal contact feature for facilitating placement of a user's finger with the knob;
wherein a user turns the knob by moving the arm with a finger placed at the distal contact feature, and
wherein the distal contact feature rests proximate the strings of the guitar when in a neutral position, such that the user may adjust guitar volume while strumming or picking the strings.

20. The knob of claim 19, wherein the knob body and the arm form a continuous, one-piece knob.

21. The knob of claim 19, a bottom edge of the arm forming an angle of more than 90 degrees with a circumferential side of the knob body; and a top edge of the arm forming an angle of more than 90 degrees between the knob body and the distal contact feature.
